(19) United States
(12) Patent Application Publication
(10) Pub. No.: US 2024/0042637 A1
(43) Pub. Date: Feb. 8, 2024

(54) CUTTING ELEMENT AND HAIR REMOVAL DEVICE

(71) Applicants: The Gillette Company LLC, Boston, MA (US); Gesellschaft für Diamantprodukte mbH, Neu-Ulm (DE)

(72) Inventors: Peter Bodo Gluche, Bellenberg (DE); Ralph Gretzschel, Neu-Ulm (DE); Michael Mertens, Vöhringen/lllerberg (DE); Matthias Gester, Farnborough (GB)

(21) Appl. No.: 18/380,718

(22) Filed: Oct. 17, 2023

Related U.S. Application Data
(63) Continuation of application No. PCT/EP2022/060373, filed on Apr. 20, 2022.

(30) Foreign Application Priority Data
Apr. 20, 2021 (EP) 21169482.3

(51) Int. Cl. B26B 21/56; B26B 21/60

(52) U.S. Cl. CPC B26B 21/56; B26B 21/60

(57) ABSTRACT

The present invention relates to a cutting element having a substrate with at least one aperture which includes a cutting edge along at least a portion of an inner perimeter of the aperture. The cutting edges have an asymmetric cross-sectional shape with a first face, a second face opposed to the first face and a cutting edge at the intersection of the first face and the second face. Moreover, the present invention relates to a hair removal device including such cutting elements.

### FIELD OF THE INVENTION

The present invention relates to a cutting element comprising a substrate with at least one aperture which comprises a cutting edge along at least a portion of an inner perimeter of the aperture, wherein the cutting edges have an asymmetric cross-sectional shape with a first face, a second face opposed to the first face and a cutting edge at the intersection of the first face and the second face. Moreover, the present invention relates to a hair removal device comprising such cutting elements.

### BACKGROUND OF THE INVENTION

Conventional shaving razors contain a plurality of straight cutting edges aligned parallel to each other and these razors are moved in a direction perpendicular to the cutting edges over the user's skin to cut body hair. Typically, a handle is attached to the plurality of cutting edges at this perpendicular angle to facilitate easy operation of the razor. However, this limits these razors to being used only in this single perpendicular direction. Shaving in any other direction requires the user to change the orientation of the hand and arm holding the razor or to change the grip of the handle within the hand. As a result, it is possible to shave back and forth over the body surface but still limited to a direction that is perpendicular to the elements. Shaving sideways and in any other kind of motion, e.g. circular or in the shape of an “8” is very difficult.

It is also known that moving conventional straight cutting edges parallel to the skin result in slicing action that severely cuts the skin, because the skin bulges into the gaps between the cutting edges and hence is presented to the full length of the cutting edge as it moves parallel to the bulge (like cutting a tomato with a knife).

This can be overcome by providing a cutting element that comprises cutting edges that are shorter and surrounded on all sides by solid material to create cutting edges that are located on the inside perimeter of an aperture. An array of such apertures containing cutting edges gives better support to the skin during shaving, flattens the skin and reduces bulging of the skin into the apertures, which result in a much safer cutting element.

Furthermore, cutting edges that are located on the inside perimeter of apertures only present a very short section of cutting edge that is parallel to any direction of motion and therefore considerably reduces the slicing action and risk of cutting the user's skin.

There is therefore a need for cutting elements and hair removal devices that can be used anywhere on the body's skin surface in any form of back and forth, sideways, circular, “8”-shaped or any other motion. For instance, it is easier and more natural to remove hair from under the arm in a circular motion. It is also easier not to be constraint to up and down shaving on some difficult to reach and hard to see areas of the body.

To enable multi-directional shaving, hair removal devices consisting of a sheet of material containing circular or other shaped apertures with cutting edges provided along the internal perimeter of these apertures have been previously proposed. However, fabricating these devices from sheets of e.g. metal requires the cutting edge to protrude from the plane of the sheet material and hence point towards the skin of the user (US 2004/0187644 A1, WO2001/08856 A1, EP 0 917 934 A1, U.S. Pat. No. 5,293,768 B1). This causes severe issues with the safety of these shaving devices and this is the reason for why no such devices are available on the market today.

To improve the safety and prevent the skin from being cut by the cutting edges, it has been proposed to fabricate apertures with cutting edges along the internal perimeter that do not protrude beyond the shaving surface by etching apertures with beveled edges along the internal perimeter into e.g. silicon wafers (U.S. Pat. No. 7,124,511 B1, JP 2004/141360 A1, EP 1 173 311 A1, DE 35 26 951 A1).

It has been found that all silicon cutting edges, even with hard coatings such as DLC, are too brittle to provide for a durable shaving device, which is the reason that no such devices are available on the market today.

There is therefore a need to provide a cutting element and a hair removal device that can be used safely in a multi directional motion without much skin bulging into the apertures and with cutting edges that efficiently remove hair but not cut into the skin. This requires cutting edges along the internal perimeter of an array of apertures that lie within the plane of the array while having cutting edges with a bevel of less than 20° that is sufficiently durable to withstand frequent usage.

The present invention therefore addresses the problem to overcome the mentioned problems and to provide a cutting element which is efficient and safe to handle in multi-directional shaving, i.e. to cut the hair without cutting the skin.

This problem is solved by the cutting element with the features of claim 1 and the hair removal device with the features of claim 16. The further dependent claims define preferred embodiments of such a cutting element.

The term “comprising” in the claims and in the description of this application has the meaning that further components are not excluded. Within the scope of the present invention, the term “consisting of” should be understood as preferred embodiment of the term “comprising”. If it is defined that a group “comprises” at least a specific number of components, this should also be understood such that a group is disclosed which “consists” preferably of these components.

In the following, the term cross-sectional view refers to a view of a slice through the cutting element perpendicular to the cutting edge (if the cutting edge is straight) or perpendicular to the tangent of the cutting edge (if the cutting edge is curved) and perpendicular to the surface of the substrate of the cutting element.

The term line has to be understood as the linear extension of an connecting point (according to a cross-sectional view as in FIG. 4) between different bevels regarding the perspective view (as in FIG. 3). As an example, if a straight bevel is adjacent to a straight bevel the connecting point in the cross-sectional view is extended to a line in the perspective view. Alternatively, if a concave bevel is adjacent to a convex bevel the turning point in the cross-sectional view is extended to a line in the perspective view.

### SUMMARY OF THE INVENTION

According to the present invention a cutting element is provided which comprises a substrate with at least one aperture which comprises a cutting edge along at least a portion of an inner perimeter of the aperture, wherein the cutting edges have an asymmetric cross-sectional shape with a first face, a second face opposed to the first face and a cutting edge at the intersection of the first face and the second face.

The first face comprises a first surface. The second face comprises a primary bevel having a convex or straight cross-sectional shape and a secondary bevel having a concave cross-sectional shape.

The second face comprises a first line which connects the primary bevel and the secondary bevel. The primary bevel extends from the cutting edge to the first line. The second face has a first wedge angle θ₁ between the first surface and the primary bevel or its tangent at the cutting edge and a second wedge angle θ₂ between the first surface and the tangent of the secondary bevel at the first line. The secondary bevel extends from the first line to a second line which may be the final line of the secondary bevel or, optionally, the intersecting line of the secondary bevel with a tertiary bevel.

Preferably, the substrate has a plurality of apertures, e.g. more than 5, preferably more than 10, more preferably more than 20 and even more preferably more than apertures.

According to a preferred embodiment the cutting edge is shaped along the inner perimeter of the apertures resulting in a circular cutting edge. However, according to another preferred embodiment the cutting edge is only shaped in portions of the inner perimeter of the apertures.

The substrate of the inventive cutting element has preferably a thickness of 20 to 1000 μm, more preferably from 30 to 500 μm, and even more preferably 50 to 300 μm.

According to a preferred embodiment of the cutting element the substrate comprises a first material, more preferably essentially consists of or consists of the first material.

According to another preferred embodiment the substrate comprises a first and a second material which is arranged adjacent to the first material. More preferably, the substrate essentially consists of or consists of the first and second material. The second material can be deposited as a coating at least in regions of the first material, i.e. the second material can be an enveloping coating of the first material, or a coating deposited on the first material on the first face.

The material of the first material is in general not limited to any specific material as long it is possible to bevel this material. It is preferred that the first material is different from the second material, more preferably the second material has a higher hardness and/or a higher modulus of elasticity and/or a higher rupture stress than the first material.

However, according to an alternative embodiment the blade body comprises or consists only of the first material, i.e. an uncoated first material. In this case, the first material is preferably a material with an isotropic structure, i.e. having identical values of a property in all directions. Such isotropic materials are often better suited for shaping, independent from the shaping technology.

The first material preferably comprises or consists of a material selected from the group consisting of:
metals, preferably titanium, nickel, chromium, niobium, tungsten, tantalum, molybdenum, vanadium, platinum, germanium, iron, and alloys thereof, in particular steel,
ceramics comprising at least one element selected from the group consisting of carbon, nitrogen, boron, oxygen and combinations thereof, preferably silicon carbide, zirconium oxide, aluminum oxide, silicon nitride, boron nitride, tantalum nitride, AlTiN, TiCN, TiAlSiN, TiN, and/or TiB₂,
glass ceramics; preferably aluminum-containing glass-ceramics,
composite materials made from ceramic materials in a metallic matrix (cermets),
hard metals, preferably sintered carbide hard metals, such as tungsten carbide or titanium carbide bonded with cobalt or nickel,
silicon or germanium, preferably with the crystalline plane parallel to the second face, wafer orientation <100>, <110>, <111> or <211>,
single crystalline materials,
glass or sapphire,
polycrystalline or amorphous silicon or germanium,
mono- or polycrystalline diamond, nano-crystalline and/or ultranano-cystalline diamond like carbon (DLC), adamantine carbon and combinations thereof.

The steels used for the first material are preferably selected from the group consisting of 1095, 12C27, 14C28N, 154CM, 3Cr13MoV, 4034, 40X10C2M, 4116, 420, 440A, 440B, 440C, 5160, 5Cr15MoV, 8Cr13MoV, 95X18, 9Cr18MoV, Acuto+, ATS-34, AUS-4, AUS-6 (=6A), AUS-8 (=8A), C75, CPM-10V, CPM-3V, CPM-D2, CPM-M4, CPM-S-30V, CPM-S-35VN, CPM-S-60V, CPM-154, Cronidur-30, CTS 204P, CTS 20CP, CTS 40CP, CTS B52, CTS B75P, CTS BD-1, CTS BD-30P, CTS XHP, D2, Elmax, GIN-1, H1, N690, N695, Niolox (1.4153), Nitro-B, S70, SGPS, SK-5, Sleipner, T6MoV, VG-10, VG-2, X-15T.N., X50CrMoV15, ZDP-189.

It is preferred that the second material comprises or consists of a material selected from the group consisting of:
oxides, nitrides, carbides, borides, preferably aluminum nitride, chromium nitride, titanium nitride, titanium carbon nitride, titanium aluminum nitride, cubic boron nitride,
boron aluminum magnesium,
carbon, preferably diamond, poly-crystalline diamond, nano-crystalline diamond, diamond like carbon (DLC), and
combinations thereof.

The second material may be preferably selected from the group consisting of TiB₂, AlTiN, TiAlN, TiAlSiN, TiSiN, CrAl, CrAlN, AlCrN, CrN, TiN, TiCN and combinations thereof.

Moreover, all materials cited in the VDI guideline 2840 can be chosen for the second material.

It is particularly preferred to use a second material of nano-crystalline diamond and/or multilayers of nano-crystalline and polycrystalline diamond as second material. Relative to monocrystalline diamond, it has been shown that production of nano-crystalline diamond, compared to the production of monocrystalline diamond, can be accomplished substantially more easily and economically. Moreover, with respect to their grain size distribution nano-crystalline diamond layers are more homogeneous than polycrystalline diamond layers, the material also shows less inherent stress. Consequently, macroscopic distortion of the cutting edge is less probable.

It is preferred that the second material has a thickness of 0.15 to 20 μm, preferably 2 to 15 μm and more preferably 3 to 12 μm.

It is preferred that the second material has a modulus of elasticity (Young's modulus) of less than 1200 GPa, preferably less than 900 GPa, more preferably less than 750 GPa and even more preferably less than 500 GPa. Due to the low modulus of elasticity the hard coating becomes more flexible and more elastic. The Young's modulus is determined according to the method as disclosed in Markus Mohr et al., “Youngs modulus, fracture strength, and Poisson's ratio of nanocrystalline diamond films”, J. Appl. Phys. 116, 124308 (2014), in particular under paragraph III. B. Static measurement of Young's modulus.

The second material has preferably a transverse rupture stress σ₀ of at least 1 GPa, more preferably of at least 2.5 GPa, and even more preferably at least 5 GPa.

With respect to the definition of transverse rupture stress σ₀, reference is made to the following literature references:
R. Morrell et al., Int. Journal of Refractory Metals & Hard Materials, 28 (2010), p. 508-515;
R. Danzer et al. in “Technische keramische Werkstoffe”, published by J. Kriegesmann, HvB Press, Ellerau, ISBN 978-3-938595-00-8, chapter 6.2.3.1
“Der 4-Kugelversuch zur Ermittlung der biaxialen Biegefestigkeit spröder Werkstoffe.”

The transverse rupture stress σ₀ is thereby determined by statistical evaluation of breakage tests, e.g. in the B3B load test according to the above literature details. It is thereby defined as the breaking stress at which there is a probability of breakage of 63%.

Due to the extremely high transverse rupture stress of the second material the detachment of individual crystallites from the hard coating, in particular from the cutting edge, is almost completely suppressed. Even with long-term use, the cutting blade therefore retains its original sharpness.

The second material has preferably a hardness of at least 20 GPa. The hardness is determined by nanoindentation (Yeon-Gil Jung et. al., J. Mater. Res., Vol. 19, No. 10, p. 3076).

The second material has preferably a surface roughness Rids of less than 100 nm, more preferably less than 50 nm, and even more preferably less than 20 nm, which is calculated according to:

$${R}_{RMS} = ( \frac{1}{A} ) \int \int {Z ( x , y )}^{2} dxdy$$

A=evaluation area

Z(x,y)=the local roughness distribution

The surface roughness Rids is determined according to DIN EN ISO 25178. The mentioned surface roughness makes additional mechanical polishing of the grown second material superfluous.

In a preferred embodiment, the second material has an average grain size d₅₀ of the nano-crystalline diamond of 1 to 100 nm, preferably 5 to 90 nm more preferably from 7 to 30 nm, and even more preferably 10 to 20 nm. The average grain size d₅₀ is the diameter at which 50% of the second material is comprised of smaller particles. The average grain size d₅₀ may be determined using X-ray diffraction or transmission electron microscopy and counting of the grains.

According to a preferred embodiment, the first material and/or the second material are coated at least in regions with a low-friction material, preferably selected from the group consisting of fluoropolymer materials like PTFE, parylene, polyvinylpyrrolidone, polyethylene, polypropylene, polymethyl methacrylate, graphite, diamond-like carbon (DLC) and combinations thereof.

Moreover, the apertures have preferably a shape which is selected from the group consisting of circular, ellipsoidal, square, triangular, rectangular, trapezoidal, hexagonal, octagonal or combinations thereof.

The area of an aperture is defined as the open area enclosed by the inner perimeter. The aperture area preferably ranges from 0.2 mm² to 25 mm², more preferably from 1 mm² to 15 mm², and even more preferably from 2 mm² to 12 mm².

According to a first preferred embodiment, the first wedge angle θ₁ ranges from 10° to 90°, preferably 12° to 75°, more preferably 15° to 45° and/or the second wedge angle θ₂ ranges from 0° to 30°, preferably 5° to 20°, more preferably 8° to 15°.

It is preferred that the wedge angles fulfill the following conditions:

θ₁≥θ₂.

This condition provides a cutting element with a very stable cutting edge combined with very good cutting performance. The cutting elements according to the present invention have a low cutting force due to a thin secondary bevel with a small second wedge angle θ₂.

The cutting elements according to the present invention are strengthened by adding a primary bevel with a primary wedge angle greater than the secondary wedge angle. The primary bevel with the first wedge angle θ₁ has therefore the function to stabilize the cutting edge mechanically against damage from the cutting operation which allows a slim element body in the area of the secondary bevel without affecting the cutting performance of the element.

According to a further preferred embodiment, the primary bevel has a length d₁ being the dimension projected onto the first surface and/or the imaginary extension of the first surface taken from the cutting edge to the first line from 0.1 to 7 μm, preferably from 0.5 to 5 μm, and more preferably 1 to 3 μm. A length d₁<0.1 μm is difficult to produce since an edge of such length is too fragile and would not allow a stable use of the cutting element. It has been surprisingly found that the primary bevel stabilizes the element body with the secondary and tertiary bevel which allows a slim element in the area of the secondary bevel which offers a low cutting force. On the other hand, the primary bevel does not affect the cutting performance as long as the length d₁ is not larger than 7 μm.

Preferably, the length d₂ being the dimension projected onto the first surface and/or the imaginary extension of the first surface taken from the cutting edge to the second line ranges from 5 to 150 μm, preferably from 10 to 100 μm, and more preferably from 20 to 80 μm. The length d₂ corresponds to the penetration depth of the cutting element in the object to be cut. In general, d₂ corresponds to at least 30% of the diameter of the object to be cut, i.e. when the object is human hair which typically has a diameter of around 100 μm the length d₂ is at least 30 μm. The cutting elements according to the present invention have therefore a low cutting force due to a thin secondary bevel with a low second wedge angle θ₂

The cutting edge micro geometry ideally has a round configuration which improves the stability of the element. The cutting edge has preferably a tip radius of less than 200 nm, more preferably less than 100 nm and even more preferably less than 50 nm.

It is preferred that the tip radius r is coordinated to the average grain size d₅₀ of the hard coating. It is hereby advantageous in particular if the ratio between the tip radius r of the second material at the cutting edge and the average grain size d₅₀ of the nanocrystalline diamond hard coating r/d₅₀ is from 0.03 to 20, preferably from 0.05 to 15, and particularly preferred from 0.5 to 10.

According to a preferred embodiment, the second face further comprises a straight or concave tertiary bevel with:
the second line connecting the secondary bevel and the tertiary bevel,
the tertiary bevel extending from the second line rearward,
a third wedge angle θ₃ between the first surface and the tertiary bevel or its tangent, wherein the third wedge angle θ₃ ranges preferably from 1° to 60°, more preferably 10° to 55°, and even more preferably 30° to 46°, and most preferably is 45°.

It is preferred that the cutting edge, the primary bevel, and the secondary bevel are shaped in the second material.

It is further preferred that the second line between secondary and tertiary bevel is arranged at the boundary surface of the first material and the second material which makes the process of manufacture easier to handle and therefore more economic.

According to a further preferred embodiment, the first face comprises a quaternary bevel with:
a third line connecting the quaternary bevel and the first surface,
the quaternary bevel extending from the cutting edge to the third line,
a fourth wedge angle θ₄ between an imaginary extension of the first surface and the quaternary bevel.

The cutting element according to the present invention may be used in the field of hair or skin removal, e.g. shaving, dermaplaning, callus skin removal, but also in other fields where cutting elements are used, e.g. as a kitchen knife, vegetable peeler, slicer, wood shaver, scalpel and composite fiber material cutter.

According to the present invention also a hair removal device comprising at least one cutting element as described above is provided.

### BRIEF DESCRIPTION OF THE DRAWINGS

The present invention is further illustrated by the following figures which show specific embodiments according to the present invention. However, these specific embodiments shall not be interpreted in any limiting way with respect to the present invention as described in the claims in the general part of the specification.

FIG. 1a is a perspective view of a cutting element in accordance with the present invention;

FIG. 1B is a top view onto the second surface of a cutting element in accordance with the present invention;

FIG. 1c is a perspective view onto the first face of a cutting element in accordance with the present invention;

FIG. 2 is a top view of onto the second surface of a cutting element in accordance with the present invention;

FIG. 3 is a perspective view of a first cutting element in accordance with the present invention;

FIG. 4 is a top view onto the second surface of a cutting element in accordance with the present invention;

FIG. 5 is a cross-sectional view of a cutting element in accordance with the present invention with a convex primary bevel;

FIG. 6 is a cross-sectional view of a cutting element in accordance with the present invention with a straight primary bevel;

FIG. 7 is a cross-sectional view of a further cutting element in accordance with the present invention with a second material;

FIG. 8 is a cross-sectional view of a further cutting element in accordance with the present invention with an additional bevel on the first face;

FIG. 9 is a cross-sectional view of a further cutting element in accordance with the present invention with an additional bevel on the first face;

FIG. 10a is a first flow chart of the first part of the process for manufacturing the cutting elements;

FIG. 10b is a second flow chart of the second part of the process for manufacturing the cutting elements;

FIG. 11 is a schematic cross-sectional view of the cutting edge micro geometry showing the determination of the tip radius;

The following reference signs are used in the figures of the present application.

### REFERENCE SIGN LIST

1 cutting element
2 first face
3 second face
4, 4′,4″, 4′″ cutting edges
5 primary bevel
6 secondary bevel
7 tertiary bevel
8 quaternary bevel
9 first surface
9′ imaginary extension of the first surface
10 first line
11 second line
12 third line
15 element body
16 cutting edge
18 first material
19 second material
20 boundary surface
22 substrate
60 tip bisecting line
61 perpendicular line
62 circle
65 construction point
66 construction point
67 construction point
71 straight portions of aperture
72 curved portions of aperture
73 first section
74 second section
75 linear cutting edge extension
76 tangent to cutting edge
77 cross-sectional line
78 cross-sectional line
260 bisecting line
430 aperture
431 inner perimeter of aperture
432 aperture area

### DETAILED DESCRIPTION OF THE INVENTION

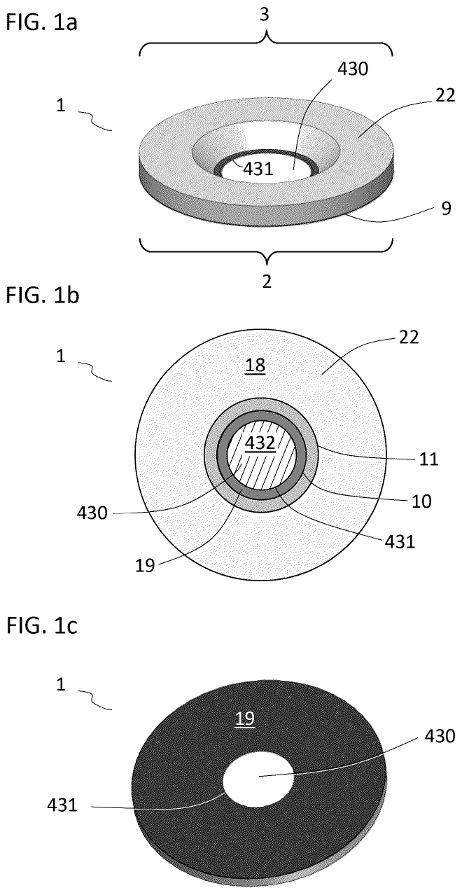

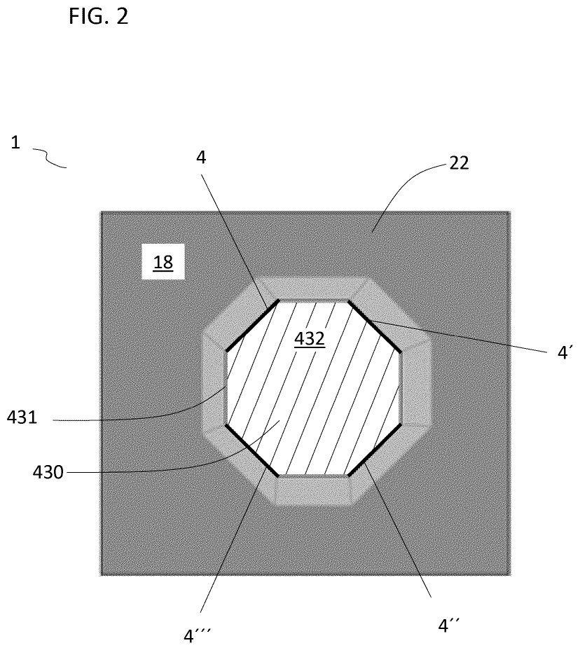

FIG. 1a shows a cutting element of the present invention in a perspective view. The cutting element with a first face 2 and second face 3 comprises a substrate 22 of a first material 18 with an aperture 430. At the first face 2 the substrate 22 has its first surface 9 with an inner perimeter 431 of the aperture 430. In this embodiment, the cutting edge 4 is shaped along the inner perimeter 431 resulting in a circular cutting edge 4.

FIG. 1b is a top view on the second face 3 of the cutting element. The substrate 22 has an aperture 430 with an inner perimeter 431 and an aperture area 432. The substrate comprises a first material 18 and a second material 19 (partially visible in this perspective) wherein the cutting edge is shaped along the inner perimeter 431 and in the second material 19.

FIG. 1c is a perspective view onto the first face 2 of the cutting element which shows the second material 19 having an aperture with an inner perimeter 431.

FIG. 2 is a top view onto the second face 3 of a cutting element of the present invention in a perspective view. The cutting element with a first face 2 (not visible in this perspective) and a second face 3 comprises a substrate 22 of a first material 18 with an aperture 430 having the shape of an octagon. At the first face 2 (not visible in this perspective), the substrate 22 has its first surface 9 with an inner perimeter 431 of the aperture 430. In this embodiment, the cutting edges 4, 4′, 4″, 4′″ are shaped only in portions of the inner perimeter 431, i.e. every second side of the octagon has a cutting edge.

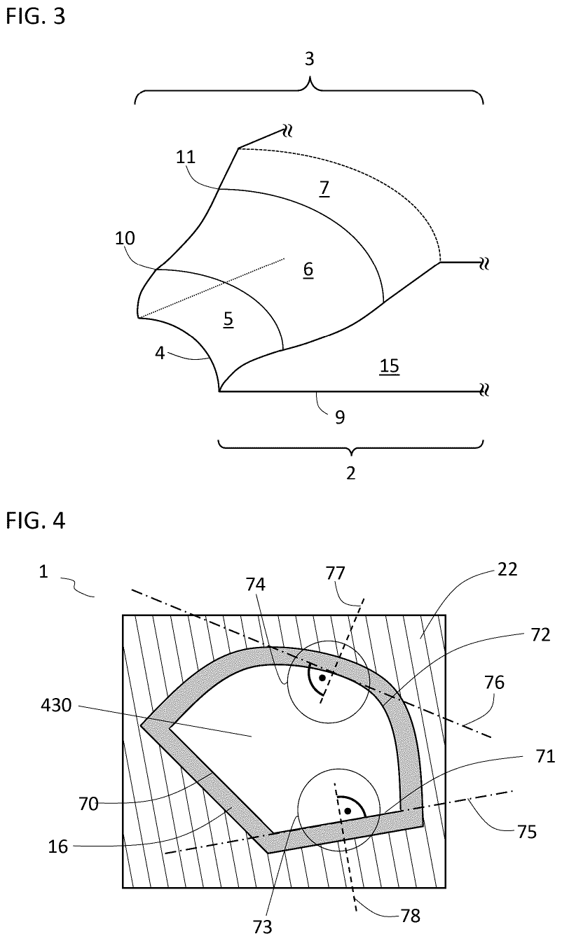

FIG. 3 is a perspective view of the cutting element according to the present invention. This cutting element 1 has an element body 15 which comprises a first face 2 and a second face 3 which is opposed to the first face 2. At the intersection of the first face 2 and the second face 3 a cutting edge 4 is located. The cutting edge 4 has curved portions. The first face 2 comprises a plane first surface 9 while the second face 3 is segmented in different bevels. The second face 3 comprises a convexly shaped primary bevel 5, a concavely shaped secondary bevel 6 and a straight or concave tertiary bevel 7. The primary bevel 5 is connected via a first line 10 with the secondary bevel 6 which on the other end is connected to the tertiary bevel 7 via a second line 11.

FIG. 4 is a top view onto the second surface of a cutting element and illustrates what is meant by the cross-section within the scope of the present invention. The substrate 22 has an aperture 430 shaped with a cutting edge 16 with two straight portions 70, 71 and one curved portion 72 where the cutting edges are shaped. In the first section 74 of the straight portion 71 the slice goes through the substrate 22 perpendicular to the linear cutting-edge extension 75 corresponding to the cross-sectional line 78. In the second section 73 of the curved portion 72 the slice goes through the substrate 22 perpendicular to the tangent of the cutting edge 76 corresponding to the cross-sectional line 77.

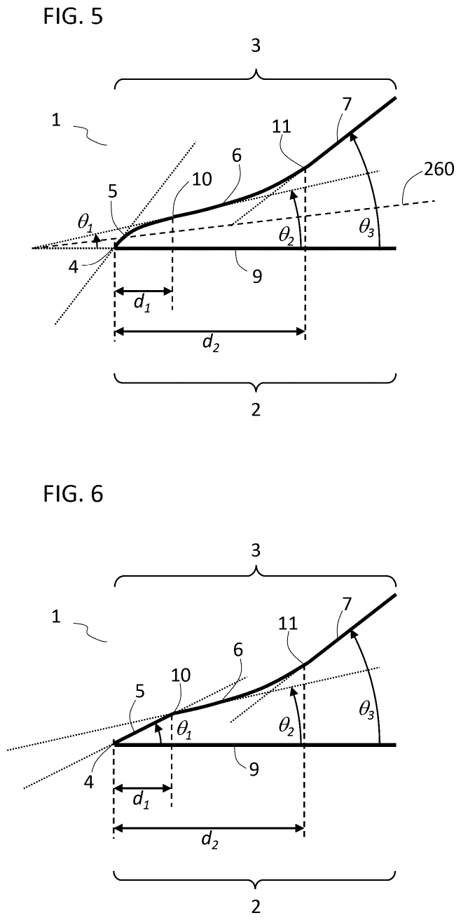

In FIG. 5, a cross-sectional view of the cutting element according to the present invention is shown. This cutting element 1 has a first face 2 and a second face 3 which is opposed to the first face 2. At the intersection of the first face 2 and the second phase 3 a cutting edge 4 is located. The first face 2 comprises a planar first surface 9 while the second face 3 is segmented in different bevels. The second face 3 of the cutting element 1 has a convexly shaped primary bevel 5 with a first wedge angle θ₁ between the first surface 9 and the tangent of the primary bevel 5 at cutting edge 4. The secondary bevel 6 is shaped concavely and has a second wedge angle θ₂ between the first surface 9 and the tangent of the secondary bevel 6 at line 10 with a bisecting line 260 of the secondary wedge angle θ. θ₂ is smaller than θ₁. The straight tertiary bevel 7 has a third wedge angle θ₃ which is larger than θ₂. The primary bevel 5 has a length d₁ being the dimension projected onto the first surface 9 which is in the range from 0.1 to 7 μm. The primary bevel 5 and the secondary bevel 6 together have a length d₂ being the dimension projected onto the first surface 9 which is in the range from 5 to 150 μm, preferably from 10 to 100 μm, and more preferably from 20 to 80 μm.

In FIG. 6, a cross-sectional view of the cutting element according to the present invention is shown. This cutting element 1 has a first face 2 and a second face 3 which is opposed to the first face 2. At the intersection of the first face 2 and the second phase 3 a cutting edge 4 is located. The first face 2 comprises a planar first surface 9 while the second face 3 is segmented in different bevels. The second face 3 of the cutting element 1 has a straight primary bevel 5 with a first wedge angle θ₁ between the first surface 9 and the primary bevel 5. The secondary bevel 6 is shaped concavely and has a second wedge angle θ₂ between the first surface 9 and the tangent of the secondary bevel 6 at line 10 which is smaller than θ₁. The straight tertiary bevel 7 has a third wedge angle θ₃ which is larger than θ₂. The primary bevel has a length d₁ being the dimension projected onto the first surface 9 which is in the range from 0.1 to 7 μm. The primary bevel 5 and the secondary bevel 6 together have a length d₂ being the dimension projected onto the first surface 9 which is in the range from 5 to 150 μm, preferably from 10 to 100 μm, and more preferably from 20 to 80 μm.

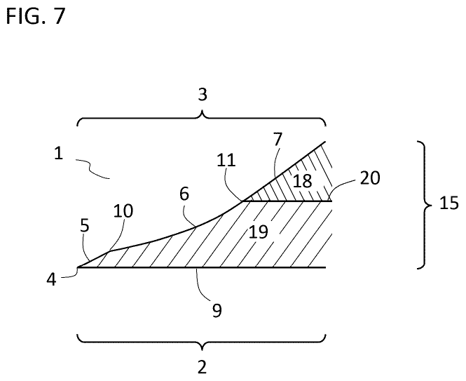

In FIG. 7, a further sectional view of a cutting element of the present invention is shown where the cutting element 1 comprising an element body 15 comprises a first material 18 and a second material 19, e.g. a diamond layer on the first material 18 at the first face 2. The straight primary bevel 5 (extending from the cutting edge 4 to the first line 10) and the concave secondary bevel 6 (extending from the first line 10 to the second line 11) are located in the second material 19 while the tertiary bevel 7 is located in the first material 18. The first material 18 and the second material 19 are separated by a boundary surface 20. As shown in FIG. 5, the first bevel may alternatively be convexly shaped.

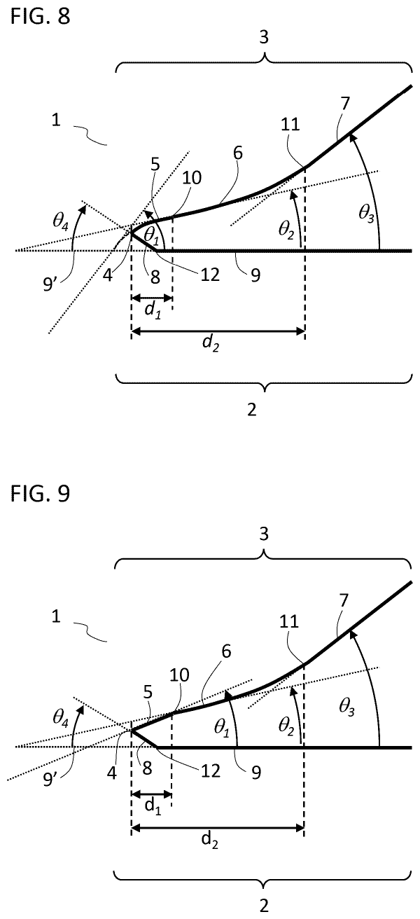

FIG. 8 shows an embodiment according to the present invention of a cutting element 1 with a first face 2 and a second face 3. The second face 3 has a convex primary bevel 5, a concave secondary bevel 6 and a straight tertiary bevel 7. On the first face 2 between the surface 9 and the cutting edge 4, a further quaternary bevel 8 is located. The angle between the quaternary bevel 8 and the surface 9 is θ₄. The wedge angle θ₁ between the tangent of the convex primary bevel 5 at cutting edge 4 and the surface 9 is larger than the wedge angle θ₂ between the tangent of the concave secondary bevel 6 at line 10 and the surface 9. Moreover, the wedge angle θ₃ between the straight tertiary bevel 7 and the surface 9 is larger than θ₂. The primary bevel 5 has a length d₁ being the dimension projected onto the first surface 9 and the imaginary extension of the first surface 9′ which is in the range from 0.1 to 7 μm. The primary bevel 5 and the secondary bevel 6 together have a length d₂ being the dimension projected onto the first surface 9 and the imaginary extension of the first surface 9′ which is in the range from 5 to 150 μm, preferably from 10 to 100 μm, and more preferably from 20 to 80 μm.

FIG. 9 shows a further cross-sectional view of an embodiment according to the present invention of a cutting element 1 with a first face 2 and a second face 3. The second face 3 has a straight primary bevel 5, a concave secondary bevel 6 and a straight tertiary bevel 7. On the first face 2 between the surface 9 and the cutting edge 4, a further quaternary bevel 8 is located. The angle between the quaternary bevel 8 and the imaginary extension of the first surface 9′ is θ₄. The wedge angle θ₁ between the straight primary bevel 5 and the surface 9 is larger than the wedge angle θ₂ between the tangent of the concave secondary bevel 6 at line 10 and the surface 9. Moreover, the wedge angle θ₃ between the straight tertiary bevel 7 and the surface 9 is larger than θ₂. The primary bevel 5 has a length d₁ being the dimension projected onto the first surface 9 and the imaginary extension of the first surface 9′ which is in the range from 0.1 to 7 μm. The primary bevel 5 and the secondary bevel 6 together have a length d₂ being the dimension projected onto the first surface 9 and the imaginary extension of the first surface 9′ which is in the range from 5 to 150 μm, preferably from 10 to 100 μm, and more preferably from 20 to 80 μm.

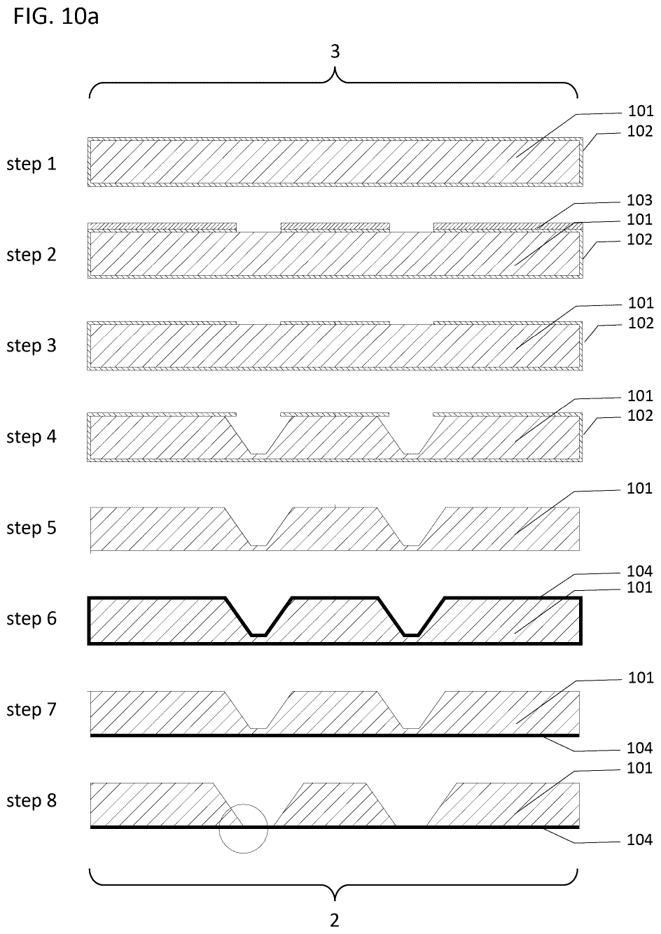

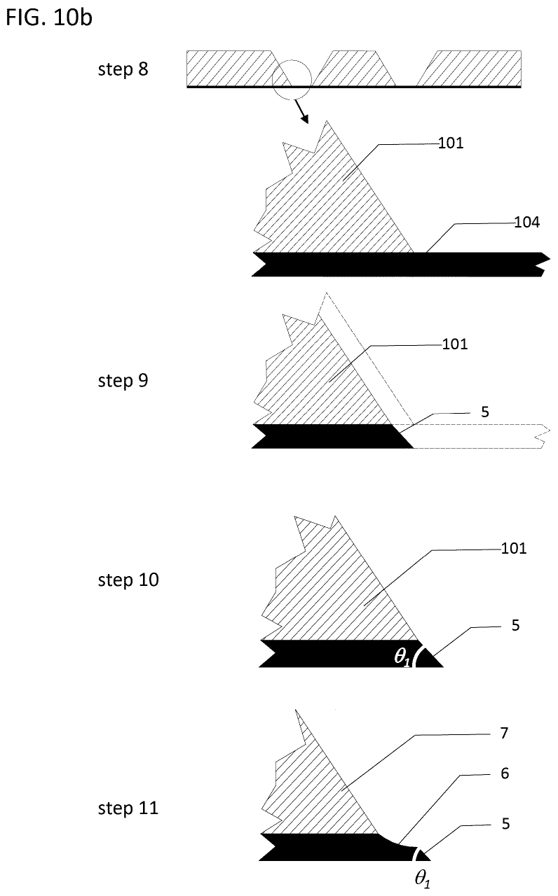

In FIGS. 10a and 10b flow charts of the inventive process are shown.

In FIG. 10a, in a first step 1, a silicon wafer 101 is coated by PE-CVD or thermal treatment (low pressure CVD) with a silicon nitride (Si₃N₄) layer 102 as protection layer for the silicon. The layer thickness and deposition procedure must be chosen carefully to enable sufficient chemical stability to withstand the following etching steps. In step 2, a photoresist 103 is deposited onto the Si₃N₄ coated substrate and subsequently patterned by photolithography. The (Si₃N₄) layer is then structured by e.g. CF₄-plasma reactive ion etching (RIE) using the patterned photoresist as mask. After patterning, the photoresist 103 is stripped by organic solvents in step 3. The remaining, patterned Si₃N₄ layer 102 serves as a mask for the following prestructuring step 4 of the silicon wafer 101 e.g. by anisotropic wet chemical etching in KOH. The etching process is ended when the structures on the second face 3 have reached a predetermined depth and a continuous silicon first face 2 remains. Alternatively, other wet- and dry chemical processes may be suited, e.g. isotropic wet chemical etching in HF/HNO₃ solutions or the application of fluorine containing plasmas. In the following step 5, the remaining Si₃N₄ is removed by, e.g. hydrofluoric acid (HF) or fluorine plasma treatment. In step 6, the pre-structured Si-substrate is coated with an approx. 10 μm thin diamond layer 104, e.g. nanocrystalline diamond. The diamond layer 104 can be deposited onto the pre-structured second surface 3 and the continuous first surface 2 of the Si-wafer 101 (as shown in step 6) or only on the continuous first surface 2 of the Si-wafer (not shown here). In the case of double-sided coating, the diamond layer 104 on the structured second surface 3 has to be removed in a further step 7 prior to the following edge formation steps 9-11 of the cutting element. The selective removal of the diamond layer 104 is performed e.g. by using an Ar/O₂-plasma (e.g. RIE or ICP mode), which shows a high selectivity towards the silicon substrate. In step 8, the silicon wafer 101 is thinned so that the diamond layer 104 is partially free standing without substrate material and the desired substrate thickness is achieved in the remaining regions. This step can be performed by wet chemical etching in KOH or HF/HNO₃ etchants or preferably by plasma etching in CF₄, SF₆, or CHF₃ containing plasmas in RIE or ICP mode.

In a next step 9, (FIG. 10b) the diamond layer is etched anisotropically by an Ar/O₂-plasma in an RIE system in order to form the cutting edge. By utilizing a constant ratio of the etch rates for the silicon and diamond, a straight bevel with a wedge angle θ₁ is formed. However, the process parameters can also be varied in time, e.g. decreasing the reactive component oxygen (variation of the oxygen flow/partial pressure) over time will lead to a reduced diamond etch rate in time, resulting in a curved convex primary bevel 5 as shown in FIG. 3. FIG. 10b shows the structured Si-wafer 101 and the diamond layer 104 prior to the etching step 9 in a larger magnification, Step 9 shows the resulting first bevel 5 after etching. Finally, steps 10 and 11 illustrate the formation of the secondary bevel 6. This step also involves simultaneous anisotropic etching of the diamond layer and the silicon performed, e.g. by an Ar/O₂ plasma in an RIE system. The silicon acts as mask for the diamond layer 104. However, similar to step 9 the etch rate ratio between silicon and diamond may be varied in time. To form the concave secondary bevel 6 shown in step 11 an etch rate that increases over time for the diamond and a constant etch rate for silicon are used. Alternatively, the silicon etch rate may be decreased over time at a constant etch rate for the diamond. Process details are disclosed for instance in DE 198 59 905 A1.

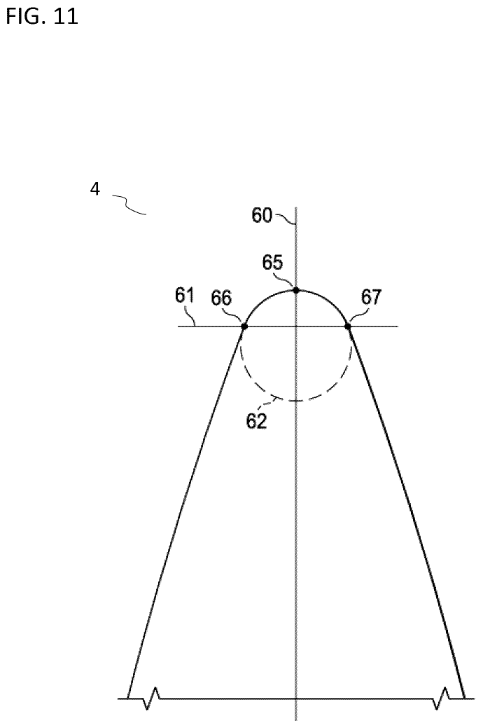

In FIG. 11, it is shown how the tip radius can be determined. The tip radius is determined by first drawing a tip bisecting line 60 bisecting the cross-sectional image of the first bevel of the cutting edge 1 in half. Where the tip bisecting line 60 bisects the first bevel point 65 is drawn. A second line 61 is drawn perpendicular to the tip bisecting line 60 at a distance of 100 nm from point 65. Where line 61 bisects the first bevel two additional points 66 and 67 are drawn. A circle 62 is then constructed from points 65, 66 and 67. The radius of circle 62 is the tip radius for the cutting element.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A cutting element comprising a substrate with at least one aperture which comprises a cutting edge along at least a portion of a perimeter of the aperture, the cutting edges having an asymmetric cross-sectional shape with a first face, a second face opposed to the first face and a cutting edge at the intersection of the first face and the second face, wherein:
the first face comprises a first surface,
the second face comprises primary bevel having a convex or straight cross-sectional shape and a secondary bevel having a concave cross-sectional shape, with
a first line connecting the primary bevel and the secondary bevel,
the primary bevel extending from the cutting edge to the first line,
the secondary bevel extending from the first line to a second line,
a first wedge angle θ₁ between the first surface and the primary bevel or its tangent at the cutting edge,
a second wedge angle θ₂ between the first surface and the tangent of the secondary bevel at the line.

2. The cutting element of claim 1, wherein the substrate has a thickness of 20 to 1000 μm, preferably 30 to 500 μm, and more preferably 50 to 300 μm.

3. The cutting element of claim 1, wherein the substrate comprises a first material (or comprises a first material and a second material adjacent to the first material.

4. The cutting element of claim 3, wherein the first material comprises or consists of:
metals, preferably titanium, nickel, chromium, niobium, tungsten, tantalum, molybdenum, vanadium, platinum, germanium, iron, and alloys thereof, in particular steel,
ceramics comprising at least one element selected from the group consisting of carbon, nitrogen, boron, oxygen and combinations thereof, preferably silicon carbide, zirconium oxide, aluminum oxide, silicon nitride, boron nitride, tantalum nitride, TiAlN, TiCN, and/or TiB₂,
glass ceramics; preferably aluminum-containing glass-ceramics,
composite materials made from ceramic materials in a metallic matrix (cermets),
hard metals, preferably sintered carbide hard metals, such as tungsten carbide or titanium carbide bonded with cobalt or nickel,
silicon or germanium, preferably with the crystalline plane parallel to the second face orientation <100>, <110>, <111> or <211>,
single crystalline materials,
glass or sapphire,
polycrystalline or amorphous silicon or germanium,
mono- or polycrystalline diamond, diamond like carbon (DLC), adamantine carbon and
combinations thereof.

5. The cutting element of claim 3, wherein the second material comprises a material selected from the group consisting of:
oxides, nitrides, carbides, borides, preferably aluminum nitride, chromium nitride, titanium nitride, titanium carbon nitride, titanium aluminum nitride, cubic boron nitride,
boron aluminum magnesium,
carbon, preferably diamond, nano-crystalline diamond, diamond like carbon (DLC) like tetrahedral amorphous carbon, and
combinations thereof.

6. The cutting element of claim 3, wherein the second material fulfills at least one of the following properties:
a thickness of 0.15 to 20 μm, preferably 2 to 15 μm and more preferably 3 to 12 μm,
a modulus of elasticity of less than 1200 GPa, preferably less than 900 GPa, more preferably less than 750 GPa,
a transverse rupture stress σ₀ of at least 1 GPa, preferably at least 2.5 GPa, more preferably at least 5 GPa
a hardness of at least 20 GPa.

7. The cutting element of claim 3, wherein the material of the second material is nanocrystalline diamond and fulfills at least one of the following properties:
an average surface roughness Rids of less than 100 nm, less than 50 nm, more preferably less than 20 nm,
an average grain size d₅₀ of the fine-crystalline diamond of 1 to 100 nm, preferably from 5 to 90 nm, more preferably from 7 to 30 nm, and even more preferably 10 to 20 nm.

8. The cutting element of claim 3, wherein the first material and/or the second material are coated at least in regions with a low-friction material, preferably selected from the group consisting of fluoropolymer materials like PTFE, parylene, polyvinylpyrrolidone, polyethylene, polypropylene, polymethyl methacrylate, graphite, diamond-like carbon (DLC) and combinations thereof.

9. The cutting element of claim 1, wherein the at least one aperture has a form which is selected from the group consisting of circular, ellipsoidal, square, triangular, rectangular, trapezoidal, hexagonal, octagonal or combinations thereof, wherein it is preferred that the at least one aperture has an aperture area ranging from 0.2 mm² to 25 mm², preferably from 1 mm² to 15 mm², more preferably from 2 mm² to 12 mm².

10. The cutting element of claim 1, wherein the first wedge angle θ₁ ranges from 10° to 90°, preferably 12° to 75°, more preferably 15° to 45° and/or the second wedge angle θ₂ ranges from 0° to 30°, preferably 5° to 20°, more preferably 8° to 15°, wherein it is preferred that θ₁>θ₂.

11. The cutting element of claim 1, wherein the primary bevel has a length d₁ being the dimension projected onto the first surface and/or the imaginary extension of the first surface taken from the cutting edge to the first line from 0.1 to 7 μm, preferably from 0.5 to 5 μm, more preferably from 1 to 3 μm and/or the dimension projected onto the first surface and/or the imaginary extension of the first surface taken from the cutting edge to the second line has a length d₂ which ranges from 5 to 150 μm, preferably from 10 to 100 μm, more preferably from 30 to 80 μm.

12. The cutting element of claim 1, wherein the cutting edge has a tip radius of less than 200 nm, preferably less than 100 nm and more preferably less than 50 nm.

13. The cutting element of claim 1, wherein the second face further comprises a straight or concave tertiary bevel with:
the tertiary bevel extending from the second line rearward,
a third wedge angle θ₃ between the first surface and the tertiary bevel or its tangent, wherein the third wedge angle θ₃ ranges preferably from 1° to 60°, more preferably 10° to 55°, and even more preferably 30° to 46°, and most preferably is 45°.

14. The cutting element of claim 3, wherein the cutting edge, the primary bevel and the secondary bevel are shaped within the second material and/or the second line is arranged at the boundary surface of the first material and the second material.

15. The cutting element of claim 1, wherein the first face comprises a quaternary bevel with:
a third line connecting the quaternary bevel and the first surface,
the quaternary bevel extending from the cutting edge to the third line,
a fourth wedge angle θ₄ between an imaginary extension of the first surface and the quaternary bevel.

16. A hair removal device comprising the cutting element of claim 1.
